(19) United States
(12) Patent Application Publication
(10) Pub. No.: US 2017/0218802 A1
(43) Pub. Date: Aug. 3, 2017

(54) OIL STRAINER

(71) Applicant: DaikyoNishikawa Corporation, Hiroshima (JP)

(72) Inventor: Toshiya TAKANO, Hiroshima (JP)

(73) Assignee: DaikyoNishikawa Corporation, Hiroshima (JP)

(21) Appl. No.: 15/488,220

(22) Filed: Apr. 14, 2017

Related U.S. Application Data
(63) Continuation of application No. PCT/JP2015/005731, filed on Nov. 17, 2015.

(30) Foreign Application Priority Data
Nov. 20, 2014 (JP) 2014-235288

(51) Int. Cl. F01M 11/03; B01D 29/05; F16H 57/04; B01D 35/30

(52) U.S. Cl. CPC F01M 11/03; B01D 35/30; B01D 29/05; F16H 57/0404

(57) ABSTRACT

A casing includes: a flat portion housing a filter; an oil outlet cylinder projecting from the flat portion, having a cylindrical shape, and being provided with an oil outlet opening at a distal end; and an extension portion extending a flow passage cross section of a proximal end portion of the oil outlet cylinder in a width direction of the flat portion.

### CROSS-REFERENCE TO RELATED APPLICATIONS

This is a continuation of International Application No. PCT/JP2015/005731 filed on Nov. 17, 2015, which claims priority to Japanese Patent Application No. 2014-235288 filed on Nov. 20, 2014. The entire disclosures of these applications are incorporated by reference herein.

### BACKGROUND

The present disclosure relates to an oil strainer for use in, for example, an engine or an automatic transmission mounted in an automobile.

Generally, an oil strainer includes a filter for filtering oil, and a casing housing the filter. The casing has an oil inlet opening through which oil in an oil pan is sucked and an oil outlet opening through which the filtered oil flows out. Thus, the oil strainer is configured such that the oil that has entered the casing through the oil inlet opening is filtered by the filter, and then, flows out through the oil outlet opening.

An oil pan in which an oil strainer is arranged may be designed thin, and in such a case, it is required that the casing of the oil strainer have a small dimension in the vertical direction. Further, various components and parts may be arranged inside an oil pan, and in such a case, it is required that the casing of the oil strainer be thin so as to prevent interference with the various components and parts in the oil pan.

For example, Japanese Patent No. 4054745 discloses an oil strainer having a thin casing. The casing of Japanese Patent No. 4054745 is flat and capable of housing a filter having a large effective filtration area, thanks to its flat shape. Thus, this oil strainer may ensure the filtration capability.

### SUMMARY

However, making a casing flat in order to increase the effective filtration area of a filter as disclosed in Japanese Patent No. 4054745 results in narrowing an oil passage toward an oil outlet opening. In addition, since an oil outlet opening generally has a circular shape, the cross-sectional shape of the oil passage changes significantly from the casing to the oil outlet opening. In this case, it is conceivable to increase the distance from the casing to the oil outlet opening in order to make the change in the cross-sectional shape of the oil passage gradual. However, such an increase in the distance results in an increase in the size of the oil strainer, and reduces layout flexibility in the oil pan. In view of this, the distance from the casing to the oil outlet opening has to be short, and consequently, the cross-sectional shape of the oil passage inevitably changes abruptly. This abrupt change in the cross-sectional shape of the oil passage hinders the oil in the casing from flowing smoothly toward the oil outlet opening. As a result, flow resistance of oil can increase disadvantageously.

In view of the foregoing, it is therefore an object of the present disclosure to provide an oil strainer which includes a flat casing which houses a filter and which is capable of allowing oil to flow smoothly toward an oil outlet and of reducing flow resistance of the oil.

To achieve the above object, the oil strainer of the present disclosure includes a casing which has a flat portion housing a filter and an oil outlet cylinder including an oil outlet opening. The oil strainer of the present disclosure further includes an extension portion which extends an oil passage cross section of a proximal end portion of the oil outlet cylinder in a width direction of the flat portion.

A first aspect of the present disclosure relates to an oil strainer. The oil strainer includes:

a filter (2) filtering oil; and

a casing (3) housing the filter (2), and having an oil inlet opening (5) through which the oil flows into the casing (3), and an oil outlet opening (4) through which the oil which has been filtered in the casing (3) flows out of the casing (3).

The casing (3) includes a flat portion (3a) having a flat shape with an arbitrary thickness and housing the filter (2), an oil outlet cylinder (3b) projecting from the flat portion (3a), having a cylindrical shape with an inside diameter smaller than a width, of the flat portion (3a), being perpendicular to a direction of an oil flow, and provided with the oil outlet opening (4) at a distal end of the oil outlet cylinder (3b), and an extension portion (13) extending a flow passage cross section of a proximal end portion of the oil outlet cylinder (3b) in a width direction of the flat portion (3a).

According to this aspect, since the portion in which the filter is housed is flat, the oil strainer may be arranged in a thin oil pan. In addition, interference of the oil strainer with various parts arranged in such an oil pan may be substantially prevented. Further, housing the filter in the flat portion may ensure that the filter has a sufficient effective filtration area, and may enhance the filtration capability.

The oil that has been filtered by the filter flows out of the flat portion into the oil outlet cylinder, and then flows out through the oil outlet opening. Here, since the proximal end portion of the oil outlet cylinder has a flow passage cross section extended due to the formation of the extension portion, even if the cross-sectional shape of the flat portion significantly differs from that of the oil outlet opening, the presence of the extension portion provided between the flat portion and the oil outlet opening makes the abrupt change in the cross-sectional shape gradual. As a result, the oil is allowed to flow smoothly from the flat portion toward the oil outlet opening, and flow resistance of the oil decreases.

A second aspect of the present disclosure is an embodiment of the first aspect. In the second aspect,

the extension portion (13) is located downstream, in a direction of oil flow, of a housing room (R) provided in the flat portion (3a) and housing the filter (2), and includes hollow space (S) communicating with the proximal end portion of the oil outlet cylinder (3b).

The above configuration enables the oil that has been filtered by the filter to flow into the hollow space of the extension portion, located downstream of the filter. This may reliably extend the flow passage cross section of the proximal end portion of the oil outlet cylinder. After having entered the hollow space, the oil flows into a distal end portion of the oil outlet cylinder to flow out through the oil outlet opening. Thus, the oil flows from the flat portion to the oil outlet opening even more smoothly.

A third aspect of the present disclosure is an embodiment of the first or second aspect. In the third aspect,

the casing (3) is formed by welding together a first casing component (10) and a second casing component (20) which are separate from each other in a thickness direction of the flat portion (3a).

The extension portion (13) protrudes from a proximal end portion of a peripheral wall (12) of the first casing component (10) toward an outside of the first casing component (10).

A rib (15a) is formed in a distal end portion of the peripheral wall (12) of the first casing component (10).

It is conceivable that forming the extension portion in the proximal end portion of the peripheral wall of the first casing component could make the peripheral wall easy to deform. According to the present disclosure, however, a rib is formed at the distal end portion of the peripheral wall, thereby substantially preventing the deformation of the peripheral wall in an effective manner. As a result, the first and second casing components may be welded reliably, while the deformation of the peripheral wall may be substantially prevented.

According to the first aspect of the present disclosure, the casing has the oil outlet cylinder projecting from the flat portion, which houses the filter, and having the oil outlet opening at the distal end, and the extension portion extends a flow passage cross section of the proximal end portion of the oil outlet cylinder in a width direction of the flat portion. In this manner, the abrupt change in the cross-sectional shape between the flat portion and the oil outlet opening becomes gradual. Thus, the oil is allowed to flow smoothly toward the oil outlet opening, and flow resistance of the oil may be reduced.

According to the second aspect of the present disclosure, the extension portion is located downstream, in the direction of the oil flow, of the filter housing room, and includes the hollow space communicating with the proximal end portion of the oil outlet cylinder.

Thus, the oil may be allowed to flow from the flat portion to the oil outlet opening more smoothly.

According to the third aspect of the present disclosure, when the first casing component and the second casing component are welded together to form the casing, deformation of the peripheral wall of the first casing component may be substantially prevented by the configuration in which the extension portion is formed in the proximal end portion of the peripheral wall of the first casing component, and the rib is formed in the distal end portion of the peripheral wall. Thus, the first and second casing components may be welded reliably, and a decrease in the weld strength may be substantially prevented.

### BRIEF DESCRIPTION OF THE DRAWINGS

FIG. 1 is a perspective view of an oil strainer according to an embodiment, as viewed from above.

FIG. 2 is a perspective view of the oil strainer, as viewed from below.

FIG. 3 is a perspective view of the oil strainer with a lower casing component detached from the oil strainer, as viewed from below.

FIG. 4 is a perspective view of a filter, as viewed from below.

FIG. 5 corresponds to a cross-sectional view taken along the line V-V in FIG. 1, and illustrating the oil strainer with the lower casing component detached from the oil strainer.

FIG. 6 illustrates an upper casing component, as viewed from an oil outlet opening.

FIG. 7 is a perspective view of the upper casing component, as viewed from above.

FIG. 8 corresponds to a cross-sectional view taken along the line V-V in FIG. 1, and illustrating the oil strainer as viewed from above.

### DETAILED DESCRIPTION

An embodiment of the present disclosure will be described below in detail with reference to the drawings. Note that the following embodiment is merely a beneficial example in nature, and is not intended to limit the scope, application, or uses of the present disclosure.

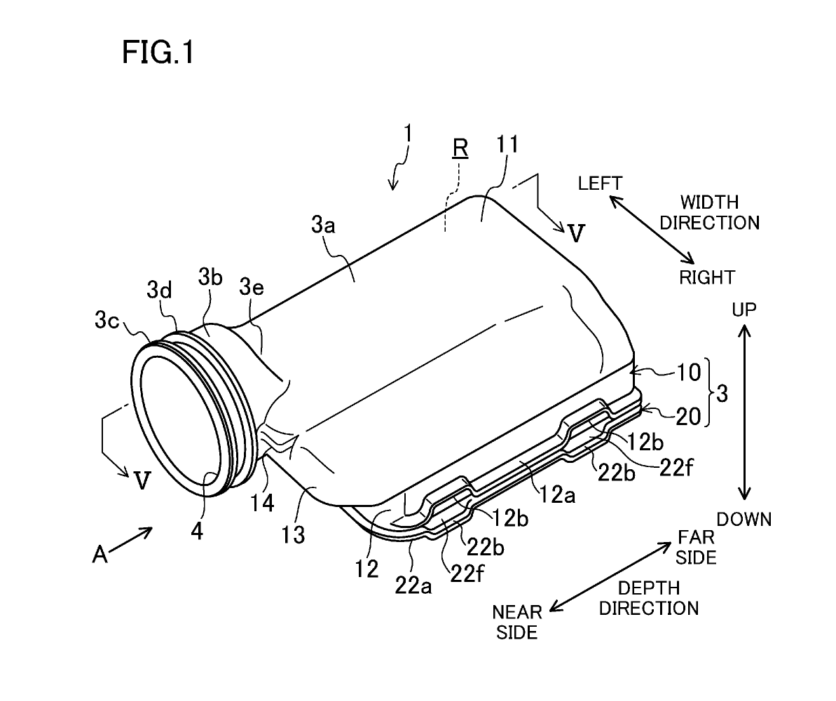

FIG. 1 is a perspective view of an oil strainer 1 according to an embodiment of the present disclosure, as viewed from above. For example, the oil strainer 1 may be arranged in an oil pan (not shown) of an engine or an oil pan (not shown) of an automatic transmission mounted in a vehicle such as an automobile. The oil strainer 1 is configured to filter oil retained in the oil pan, and then, to supply the filtered oil to an oil pump (not shown). Note that the oil strainer 1 may be arranged not only in an engine or an automatic transmission, but also in a machine in which oil is circulated.

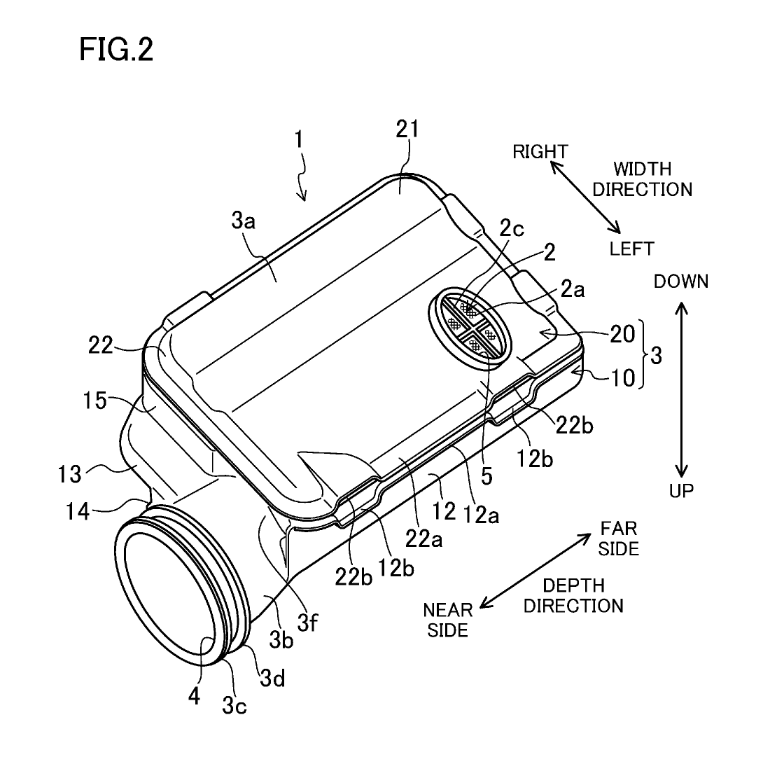

The oil strainer 1 includes a filter 2 (illustrated in FIGS. 2-5 and 8) configured to filter oil, and a casing 3 (illustrated in FIGS. 1 and 2) housing the filter 2. The casing 3 includes a flat portion 3a having a flat shape with an arbitrary thickness, and an oil outlet cylinder 3b. The flat portion 3a is configured to house the filter 2, and corresponds to a portion, of the casing 3, extending horizontally and having a thick plate shape, in this embodiment. The flat portion 3a is shaped to have a greater dimension in a depth direction of the oil strainer 1 than in a width direction of the oil strainer 1. However, the flat portion 3a is not limited to this shape, but may be shaped to have a greater dimension in the width direction of the oil strainer 1 than in the depth width direction of the oil strainer 1. Further, the flat portion 3a may have a substantially rectangular shape, or a shape close to an ellipse or a circle, in plan view.

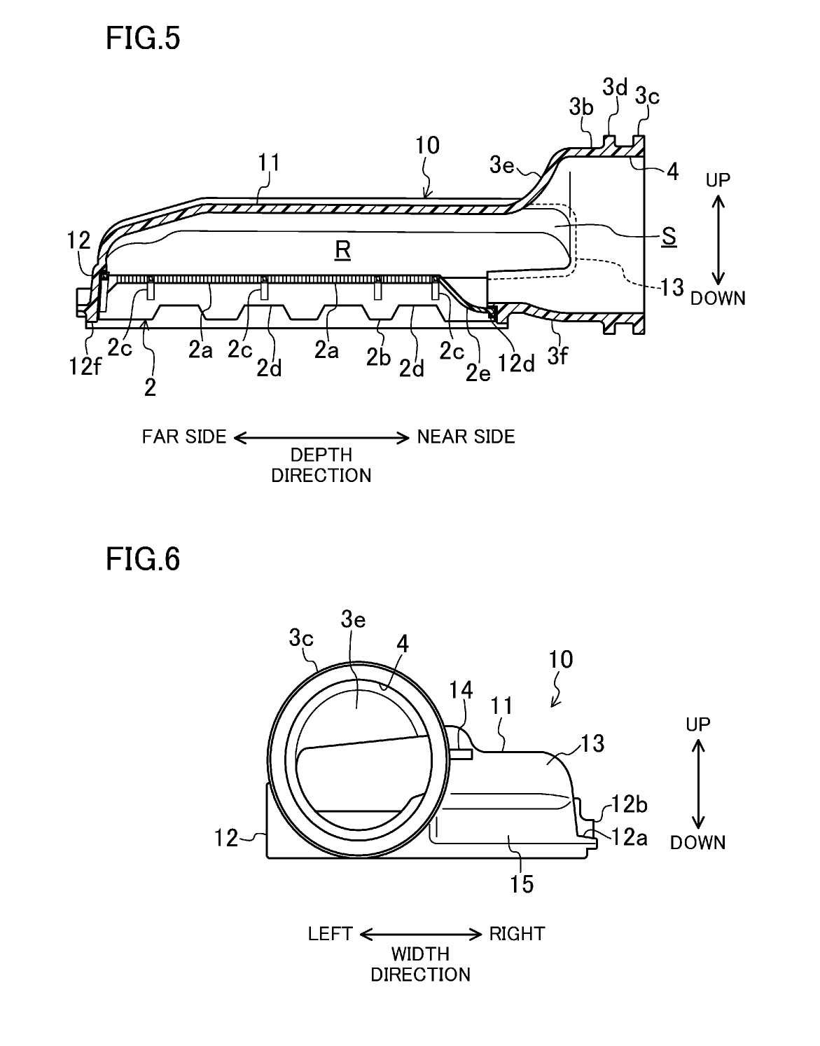

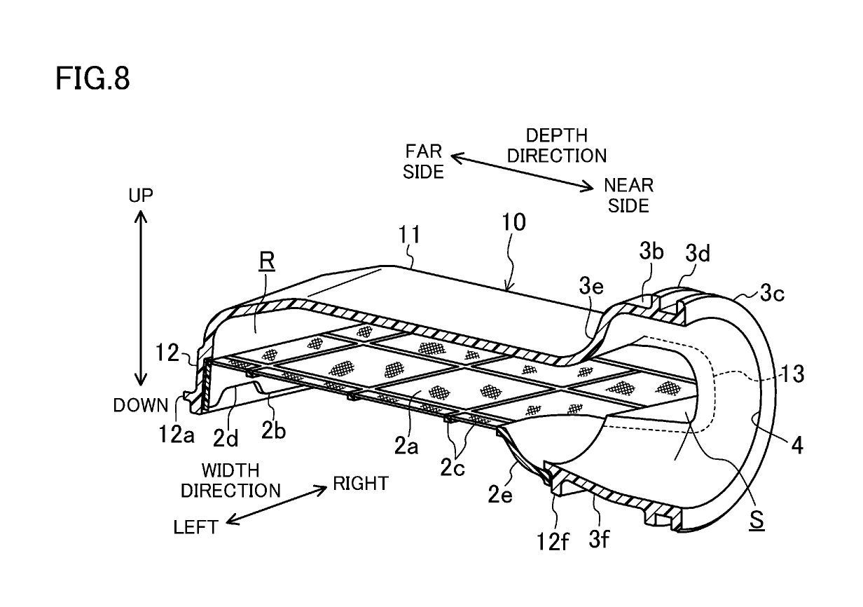

As illustrated in FIGS. 5 and 8, the flat portion 3a includes therein a filter housing room R in which the filter 2 is housed and through which the oil flows. The flat portion 3a has a longitudinal cross-section shape, taken along a line perpendicular to the depth direction, which is long in the horizontal direction. As illustrated in FIG. 2, the flat portion 3a has a lower wall 21. In the lower wall 21, an oil inlet opening 5 communicating with the filter housing room R is provided close to a far side and a left side. Thus, the oil in the oil pan enters a far side portion of the flat portion 3a. The oil inlet opening 5 may be circular or elliptic.

As illustrated in FIG. 1, the oil outlet cylinder 3b projects horizontally from an upper left portion, of the flat portion 3a, located close to the near side. Therefore, the oil that has flowed through the oil inlet opening 5 into the flat portion 3a, passes through the filter 2, while flowing inside the flat portion 3a from the far side to the near side, and then, flows out of an upper portion of the flat portion 3a. The upstream side and downstream side in the direction of the oil flow in the oil strainer 1 correspond to the far side and the near side, respectively.

The oil outlet cylinder 3b has a circular cross section in a portion between its center in the direction in which the oil outlet cylinder 3b projects (hereinafter referred to as the cylinder projecting direction) and its distal end. The inside diameter of the distal end portion of the oil outlet cylinder 3b is smaller than a width dimension, of the flat portion 3a, being perpendicular to the oil flow direction. As can be seen, the distal end portion of the oil outlet cylinder 3b has a circular cross section, whereas the flat portion 3a has a cross-section shape that is long in the horizontal direction. Thus, the oil outlet cylinder 3b and the flat portion 3a differ from each other significantly in their cross-sectional shapes.

The oil outlet cylinder 3b has, at its distal end in the cylinder projecting direction, an oil outlet opening 4 which has a circular shape. The oil outlet opening 4 communicates with the filter housing room R via the inside of the oil outlet cylinder 3b, and is configured to allow the filtered oil that has passed through the filter 2 to flow out. The oil outlet opening 4 is connected to a suction port of an oil pump (not shown). The oil outlet opening 4 and the oil inlet opening 5 have substantially the same opening area.

As illustrated in FIG. 1, an upper end of the distal end portion of the oil outlet cylinder 3b in the cylinder projecting direction is located above the upper surface of the flat portion 3a. A lower end of the distal end portion of the oil outlet cylinder 3b in the cylinder projecting direction is located above the lower surface of the flat portion 3a.

A first rib 3c projects radially outwardly from, and extends continuously and circumferentially on, the distal end portion of the oil outlet cylinder 3b in the cylinder projecting direction. Further, between the first rib 3c and a proximal end of the oil outlet cylinder 3b, a second rib 3d which is spaced from the first rib 3c projects radially outwardly from, and extends continuously and circumferentially on, the distal end portion of the oil outlet cylinder 3b in the cylinder projecting direction. A sealing member (not shown) may be fitted between the first and second ribs 3c and 3d.

The oil outlet cylinder 3b has, at a portion between its center in the cylinder projecting direction and the proximal end, an upper inclined wall portion 3e forming part of the upper wall of the oil outlet cylinder 3b. As illustrated in FIG. 5, the upper inclined wall portion 3e is inclined downwardly from the near side to the far side, i.e., toward the proximal end of the oil outlet cylinder 3b in the cylinder projecting direction. The oil outlet cylinder 3b has, at a portion between its center in the cylinder projecting direction and the proximal end, a lower inclined wall portion 3f forming part of the lower wall of the oil outlet cylinder 3b. The lower inclined wall portion 3f is inclined upwardly toward the proximal end of the oil outlet cylinder 3b in the cylinder projecting direction. Due to the formation of the upper and lower inclined wall portions 3e and 3f, the oil outlet cylinder 3b has, between the center in the cylinder projecting direction and the proximal end, a cross-sectional area decreasing toward the proximal end.

As illustrated in FIGS. 1 and 2, the casing 3 is formed by welding together an upper casing component 10 and a lower casing component 20 which are separate from each other. These casing components are welded to each other at an intermediate point in the vertical direction, i.e., in the thickness direction of the flat portion 3a. The oil outlet cylinder 3b is formed on the upper casing component 10. Each of the upper and lower casing components 10 and 20 is formed by injection-molding a resin material.

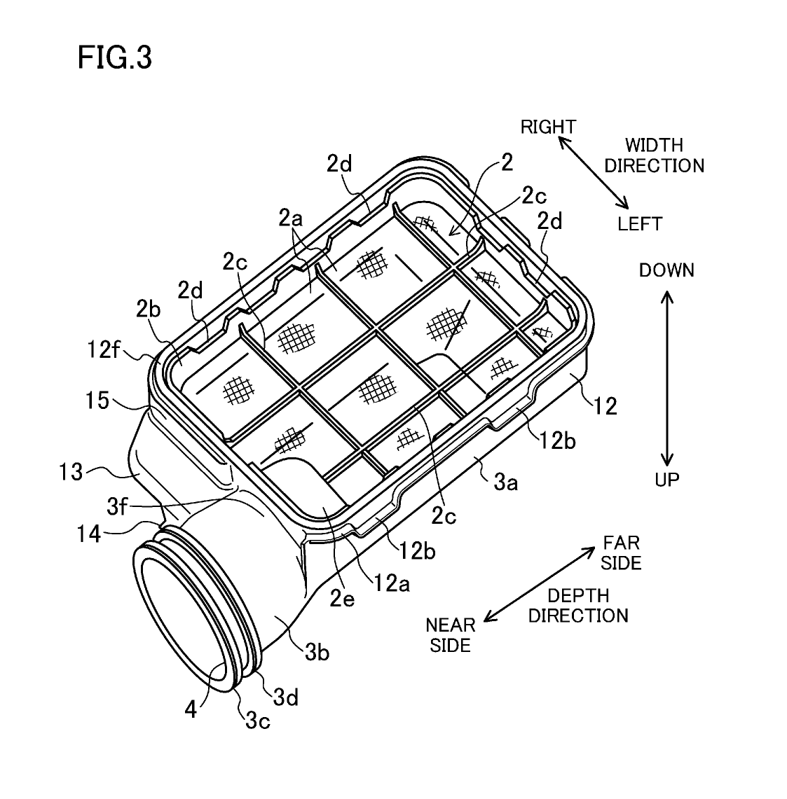

The upper casing component 10 has an upper wall 11 and a peripheral wall 12 extending downward from a peripheral edge of the upper wall 11. A left portion of the upper wall 11 protrudes upward to be located above a right portion of the upper wall 11. An upper flange 12a which projects toward the outside of the casing 3 extends circumstantially on a lower end portion of the peripheral wall 12. The upper flange 12a has a plurality of portions recessed upward, and these portions function as jig engagement portions 12b. A jig (not shown) is engaged with the jig engagement portions 12b to be employed when the upper and lower casing components 10 and 20 are welded together. As illustrated in FIG. 3, a weld rib 12f extends over the entire periphery of a lower surface of the upper flange 12a. The weld rib 12f is welded to a peripheral edge of the lower casing component 20. The welding may be performed by hot plate welding, for example. However, the welding is not limited to this, and may be performed by vibration welding, for example.

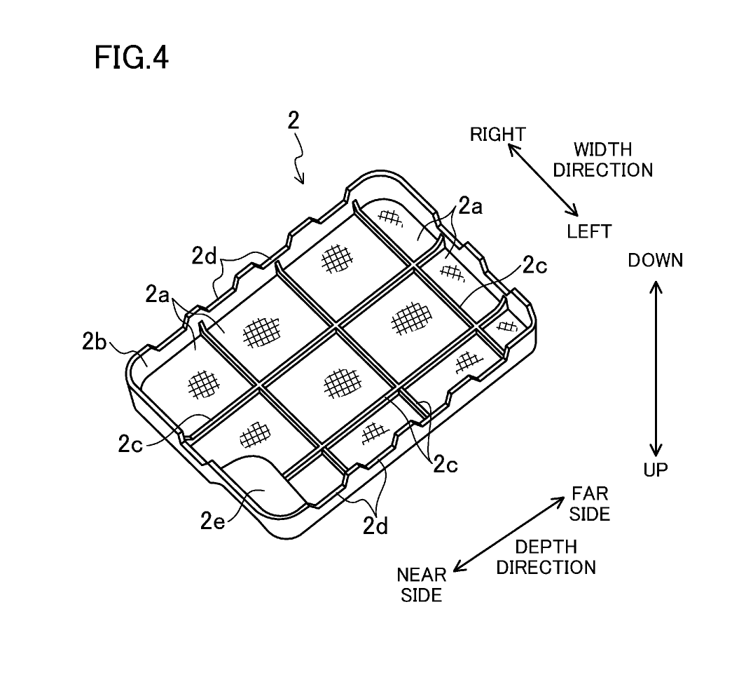

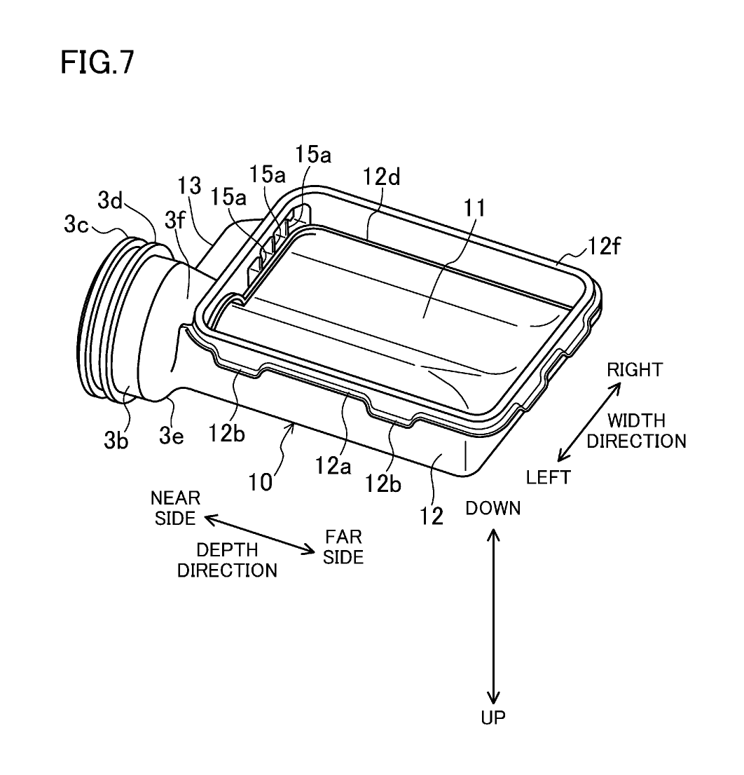

As illustrated in FIG. 7, the peripheral wall 12 of the upper casing component 10 has, on its inner surface, a step portion 12d onto which the filter 2 is fitted. As illustrated in FIG. 4, the filter 2 is a plate-shaped one formed by injection-molding a resin material. The filter 2 has a mesh portion 2a for filtering oil which passes therethrough, a frame 2b surrounding the mesh portion 2a, and a plurality of reinforcement members 2c. The mesh portion 2a is made of the resin material and is meshed finely enough to filter oil. The frame 2b is fitted onto the step portion 12d on the inner surface of the peripheral wall 12 of the upper casing component 10. The outer peripheral surface of the frame 2b is entirely in contact with the inner surface of the peripheral wall 12 of the upper casing component 10. As illustrated in FIG. 5, the mesh portion 2a is located above the frame 2b. As illustrated in FIGS. 3 and 4, the frame 2b has a plurality of notches 2d which are arranged circumstantially and spaced from each other. The reinforcement members 2c are rod-like members which extend in longitudinal and transverse directions inside the frame 2b and are integral with the mesh portion 2a to reinforce the mesh portion 2a.

As illustrated in FIG. 4, the filter 2 has a curved plate portion 2e. The curved plate portion 2e is provided in a near side left corner portion in the frame 2b. As illustrated in FIG. 3, the curved plate portion 2e is positioned in a vicinity of the proximal end of the oil outlet cylinder 3b of the casing 3 in a state where the filter 2 has been mounted to the casing 3.

The curved plate portion 2e has no mesh portion, and the oil is not allowed to pass through the curved plate portion 2e.

As illustrated in FIGS. 5 and 8, the curved plate portion 2e of the filter 2 is curved smoothly so as to become lowered as it approaches the near side of the casing 3 in a state where the filter 2 has been mounted to the casing 3. The curved plate portion 2e is arranged such that its end located close to the near side is continuous with the lower wall of the oil outlet cylinder 3b. Further, another end, of the curved plate portion 2e, located close to the far side, is at the same height as, and continuous with, the mesh potion 2a.

The curved plate portion 2e having the thus curved shape and being formed at the filter 2 may introduce part of the oil, which is flowing in the flat portion 3a and is going to enter the oil outlet cylinder 3b, also to a lower portion of the oil outlet cylinder 3b.

As illustrated in, for example, FIG. 1, an extension potion 13 is provided on the peripheral wall 12 of the upper casing component 10. The extension portion 13 is provided to extend, in the width direction of the flat portion 3a, i.e., in the rightward direction in this embodiment, a flow passage cross section of the proximal end portion of the oil outlet cylinder 3b in the cylinder projecting direction. The extension portion 13 is provided on a portion, of the peripheral wall 12 of the upper casing component 10, located close to the near side and extending in the width direction, such that the extension portion 13 is adjacent to the right side of the oil outlet cylinder 3b. The extension portion 13 protrudes from a proximal end portion (an upper portion) of the peripheral wall 12 toward the outside of the upper casing component 10. Thus, the extension portion 13 is located downstream, in the oil flow direction, of the room, inside the flat portion 3a, where the filter 2 is housed, i.e., downstream of the filter housing room R. The extension portion 13 has a greater dimension in the width direction than in the vertical direction. A left part of the extension portion 13 is integral with a wall of the proximal end portion of the oil outlet cylinder 3b in the cylinder projecting direction. A right part of the extension portion 13 is located close to the right end of the casing 3.

The extension portion 13 includes therein a hollow space S which communicates with the proximal end portion of the oil outlet cylinder 3b in the cylinder projection direction. This hollow space S is long in the width direction, and a left portion of the hollow space S communicates with at least part of the portion, of the oil outlet cylinder 3b, in which the upper inclined wall portion 3e is provided.

As illustrated in FIG. 3, the peripheral wall 12 of the upper casing component 10 has, below the extension portion 13, i.e., near the distal end of the peripheral wall 12, a protrusion 15 which protrudes toward the outside of the casing 3. Like the extension portion 13, the protrusion 15 is long in the width direction. The protrusion 15 does not protrude as much as the extension portion 13. Thus, the distal end of the extension portion 13 in its protruding direction is located outward with respect to the distal end of the protrusion 15 in its protruding direction.

As illustrated in FIG. 7, a plurality of ribs 15a is formed in a distal end portion of the peripheral wall 12 of the upper casing component 10. These ribs 15a extend in the vertical direction inside the protrusion 15, and are spaced from each other in the width direction. That is to say, the ribs 15a are arranged directly under the extension portion 13. Upper and lower ends of each rib 15a are continuous with the inner surface of the protrusion 15. In this manner, the strength of the protrusion 15 is increased, and consequently, the strength of the peripheral wall 12 is increased. A single rib 15a may be provided.

As illustrated in FIG. 1, the peripheral wall 12 of the upper casing component 10 has a projecting plate portion 14 which projects toward the outside of the casing 3. The projecting plate portion 14 projects from the distal end of the extension portion 13 in the protruding direction, and is integral with the wall of the proximal end portion of the oil outlet cylinder 3b.

As illustrated in FIG. 2, the lower casing component 20 has the lower wall 21 which covers a lower opening of the upper casing component 10. The lower casing component 20 further includes a peripheral wall 22 extending upwardly from a peripheral edge of the lower wall 21. A lower flange 22a which projects toward the outside of the casing 3 extends circumstantially on an upper end portion of the peripheral wall 22. The lower flange 22a and the upper flange 12a face each other and are spaced from each other in the vertical direction. The lower flange 22a has a plurality of jig engagement portions 22b curving downward. The jig engagement portions 22b of the lower flange 22a are at the same location as the jig engagement portions 12b of the upper flange 12a in the circumstantial direction of the casing 3. A weld rib 22f illustrated in FIG. 1 extends over the entire periphery of an upper surface of the lower flange 22a. The weld rib 22f is welded to the weld rib 12f of the upper casing component 10, thereby joining the upper and lower casing components 10 and 20 together in a fluid-tight manner.

Next, it is described how the thus configured oil strainer 1 is fabricated. First, a filter 2 is fitted onto a step portion 12d of an upper casing component 10 such that the filter 2 becomes integral with the upper casing component 10. Thereafter, the upper casing component 10 and a lower casing component 20 are each held by a weld jig such that the openings of the upper and lower casing components 10 and 20 face each other. A hot plate is inserted between the upper and lower casing components 10 and 20 to heat the casing components 10 and 20. In this heating process, although the filter 2 is also heated, the curved plate portion 2e, which is the portion placed closer to the hot plate than any other portion of the filter 2 is, does not has a mesh structure, and therefore, the filter 2 of the present disclosure is more resistant to melting than in a case where the curved plate portion 2e has a mesh structure.

After the weld rib 12f of the upper casing component 10 and the upper end portion of the peripheral wall 22 of the lower casing component 20 have molten, the hot plate is removed and the weld rib 12f of the upper casing component 10 is brought into contact with, and welded to, the weld rib 22f of the peripheral wall 22 of the lower casing component 20. In this manner, the oil strainer 1 is fabricated. When the weld rib 12f of the upper casing component 10 is brought into contact with the weld rib 22f of the peripheral wall 22 of the lower casing component 20, vertical compressive force acts on the peripheral wall 12 of the upper casing component 10. In this embodiment, since the peripheral wall 12 of which the strength is reduced by the formation of the extension portion 13 is reinforced by the ribs 15a formed in the protrusion 15, a warp which could occur in the peripheral wall 12 may be reduced. As a result, the weld rib 12f of the upper casing component 10 may be tightly pressed onto the weld rib 22f of the peripheral wall 22 of the lower casing component 20. Thus, the upper casing component 10 may be reliably welded to the lower casing component 20, and a decrease in the weld strength may be substantially prevented.

Since the oil strainer 1 fabricated in the above-described manner houses the filter 2 in the flat portion 3a that is flat in the horizontal direction, the oil strainer 1 may be thin. As a result, the oil strainer 1 may be arranged in a thin oil pan, and at the same time, interference with various parts arranged in the oil pan may be prevented. Further, the filter 2, which is housed in the flat portion 3a, has a sufficient effective filtration area, thereby enhancing the filtration capability.

After having entered the filter housing room R of the flat portion 3a through the oil inlet opening 5, the oil passes through the mesh portion 2a of the filter 2 to be filtered, while flowing upwardly toward the near side. Thereafter, the oil flows into the oil outlet cylinder 3b. Here, since the proximal end portion of the oil outlet cylinder 3b has a flow passage cross section extended due to the formation of the extension portion 13, even if the cross-sectional shape of the flat portion 3a significantly differs from that of the oil outlet opening 4, the presence of the extension portion 13 provided between the flat portion 3a and the oil outlet opening 4 makes the abrupt change in the cross-sectional shape gradual. As a result, the oil is allowed to flow smoothly from the flat portion 3a to the oil outlet opening 4, and flow resistance of the oil decreases.

Further, the extension portion 13 is located downstream, in the oil flow direction, of the filter housing room R, and has the hollow space S which communicates with the proximal end portion of the oil outlet cylinder 3b in the cylinder projecting direction. This configuration allows the oil to flow even more smoothly from the flat portion 3a to the oil outlet opening 4.

Note that although the oil outlet cylinder 3b of this embodiment projects from a left portion of the flat portion 3a, the oil outlet cylinder 3b may project from a central portion in the width direction or a right portion of the flat portion 3a. If the oil outlet cylinder 3b projects from the central portion in the width direction of the flat portion 3a, an extension portion is provided on each of the left and right sides of the oil outlet cylinder 3b (not shown).

In this manner, the flow passage cross section of the proximal end portion of the oil outlet cylinder 3b may be extended toward the left and right ends in the width direction of the flat portion 3a. If the oil outlet cylinder 3b projects from a right portion of the flat portion 3a, an extension portion is formed on the left side of the oil outlet cylinder 3b (not shown). In this manner, the flow passage cross section of the proximal end portion of the oil outlet cylinder 3b may be extended in the leftward direction of the flat portion 3a.

In the embodiment described above, the flat portion 3a of the oil strainer 1 extends in the horizontal direction. However, the flat portion 3a is not limited to this shape, and may extend in the vertical direction.

The above-described embodiment is illustrative only and should not be interpreted in any way to limit the present disclosure. All variations and modifications within a scope equivalent to the scope of the claims are encompassed in the scope of the present disclosure.

As described above, the oil strainer of the present disclosure is useful in an oil pan of an engine or an automatic transmission mounted in an automobile, for example.

What is claimed is:

1. An oil strainer comprising:
a filter filtering oil; and
a casing housing the filter, and having an oil inlet opening through which the oil flows into the casing, and an oil outlet opening through which the oil which has been filtered in the casing flows out of the casing, wherein
the casing includes
a flat portion having a flat shape with a desired thickness and housing the filter,
an oil outlet cylinder projecting from the flat portion, having a cylindrical shape with an inside diameter smaller than a width, of the flat portion, being perpendicular to a direction of an oil flow, and provided with the oil outlet opening at a distal end of the oil outlet cylinder, and
an extension portion extending a flow passage cross section of a proximal end portion of the oil outlet cylinder in a width direction of the flat portion.

2. The oil strainer of claim 1, wherein
the extension portion is located downstream, in a direction of oil flow, of a housing room provided in the flat portion and housing the filter, and includes hollow space communicating with the proximal end portion of the oil outlet cylinder.

3. The oil strainer of claim 1, wherein
the casing is formed by welding together a first casing component and a second casing component which are separate from each other in a thickness direction of the flat portion,
the extension portion protrudes from a proximal end portion of a peripheral wall of the first casing component toward an outside of the first casing component, and
a rib is formed in a distal end portion of the peripheral wall of the first casing component.
